(19) United States
(12) Patent Application Publication
(10) Pub. No.: US 2019/0190639 A1
(43) Pub. Date: Jun. 20, 2019

(54) WAVELENGTH DIVISION MULTIPLEXING PER PULSE FROM ULTRA SHORT PULSED LASERS USED IN FREE SPACE AND FIBER OPTICAL COMMUNICATION SYSTEMS

(71) Applicant: Attochron, LLC, Lexington, VA (US)

(72) Inventors: Thomas Malcolm Chaffee, Lexington, VA (US); Douglas Arthur Pinnow, Lake Elsinore, CA (US)

(21) Appl. No.: 15/842,619

(22) Filed: Dec. 14, 2017

(51) Int. Cl. H04J 14/02; H04B 10/11; H04B 10/50; H04B 10/25

(52) U.S. Cl. CPC H04J 14/02; H04B 10/25; H04B 10/503; H04B 10/11

(57) ABSTRACT

This invention relates to increasing the digital data rate of both free space and fiber optic communication systems by passing the laser beam from an ultra-short pulsed laser (USPL) source through an integrated photonic circuit that slices the relatively broadband spectral emission from the USPL into a multiplicity of narrower contiguous spectral bands. Each of these contiguous bands is individually modulated with data to form a multiplicity of communication channels that are then recombined back into a single broadband pulse stream prior to transmission to a remote receiver unit. Upon receipt at the optical receiver unit, the individual broadband pulses in the received pulse stream are sliced once again by another integrated photonic circuit back into a multiplicity of contiguous spectral channels that are directed to a multiplicity of high speed photodetectors, one detector per channel, resulting in a wavelength division multiplexing-per-pulse (WDM-per-pulse) communication system.

### CROSS REFERENCES TO RELATED APPLICATIONS

This application claims the benefit of U.S. Provisional Patent Application Ser. No. 62/434818 filed Dec. 15, 2016, titled WAVELENGTH DIVISION MULTIPLEXING PER PULSE FROM ULTRA SHORT PULSED LASERS USED IN FREE SPACE AND FIBER OPTICAL COMMUNICATION SYSTEMS the contents of which are hereby incorporated by reference herein.

### BACKGROUND OF THE INVENTION

### 1. Field of the Invention

This invention relates to increasing the digital data rate of both free space and fiber optic communication systems employing an ultra-short pulsed laser (USPL) source located in a transmitter unit by the passing the laser's beam through an integrated photonic circuit that slices the relatively broadband spectral emission in each output pulse from the USPL into a multiplicity of narrower contiguous spectral band pulses. Each of these contiguous pulses can be individually modulated with data to form a multiplicity of communication channels that are then recombined back into a single broadband pulse prior to transmission to a remote receiver unit. Upon receipt at the optical receiver unit, the individual broadband pulses in the received pulse stream are sliced once again by another integrated photonic circuit back into a multiplicity of contiguous spectral channels that are directed to a multiplicity of high speed photodetectors, one detector per channel, and associated electronics that are used to recover all of the data bits in all of the spectral slices (channels). This is a cost effective way to increase the data transmission rate for a broadband optical communication system by a method called wavelength division multiplexing-per-pulse (WDM-per-pulse) without the need for additional lasers for each optical channel or additional transmission and receiving optics.

### 2. Description of Related Art

Over the past 50 years, the technology of optically transmitting digital data from one location to another (point-to-point) has grown from infancy to become the dominant factor in world-wide communications. This growth has followed two separate branches, (1) guided transmission through optical fibers, and (2) unguided free space optical (FSO) transmission. By far, the optical fiber transmission branch has enjoyed the bulk of the growth with optical fibers now running through buildings, around neighborhoods and campuses, across nations and under the oceans interconnecting the world with high speed (high bit rate) digital data links that support a broad range of applications including the Internet.

Even though optical fiber transmission has enjoyed remarkable growth, there remain a number of important applications that can only be satisfied by using FSO communications. These include applications such as data links from earth-to-satellites, satellite-to-satellite, air-to-underwater, underwater-to-underwater and, more broadly, for any mobile application to and/or from moving transmitters and/or receivers, for example, in airplanes or other vehicles. In addition, use of FSO communication links often have a substantial economic advantages over optical fibers in stationary short-haul terrestrial applications, such as inner cities, where the cost of deploying optical fibers is quite high due to limited underground duct space and the high cost for trenching in urban areas where development is complex due to limited right-of-ways as well as the cost and time delays for obtaining permits. An especially important category for FSO communications is to quickly establish broadband communication links in emergency situations such as immediately after hurricane damage, flooding, or fires. In most of these cases, the point-to-point distances for transmission are in the range of one mile or less.

At present there are a number of companies, including fSONA (www.fSONA.com) in Canada, that offer FSO communication links that employ modulated continuous output diode laser sources similar to those used in fiber optical communication links. These laser diodes have relatively narrow spectral bandwidths and are usually used to drive just a single FSO communication channel. In practice, most FSO equipment makers in the past have sent a number of laser signals that are redundant in the hopes that some of the total signal makes it to the receiver—a strategy known as ‘link diversity’ which also nominally helps link operating distance. However, some of these FSO links employ multiple laser sources having different non-interfering wavelengths so that multiple communication channels can be operated simultaneously with common optical transmitter and receiver optics. This mode of operation, often referred to as wavelength division multiplexing (WDM), can be cost effective in providing either data redundancy or a broader data bandwidth than is possible with a single laser source.

The above strategy for using multiple laser sources having different wavelengths in FSO communication systems finds much broader applications in the field of fiber optic communications where multiplexing the modulated outputs of multiple diode lasers onto a single optical fiber is also known as WDM (see en.wikipedia.org/wiki/Wavelength-division multiplexing) and is employed by all major telecommunication companies throughout the world.

In recent years, new developments in FSO communications have revealed possible benefits in reducing atmospheric attenuation, especially in inclement weather, by transmitting data bits in very short temporal pulses (bursts), lasting, typically, less than one picosecond (1×10¹² seconds) and often in a range from one picoseconds down to one femtosecond (1×10¹⁵ seconds) but, usually, tens to several hundred femtoseconds. A class of lasers, known as ultra-short pulsed lasers (USPL), has been developed to repetitively produce such short optical pulses. This class includes the relatively large Ti: Sapphire laser operating at a variable central wavelength in the range of 0.65 to 1.10 microns, the less developed supercontinuum laser with an even broader spectral range from 0.38 to 2.4 microns (“SUPERCONTINUUM SOURCES: An even brighter future awaits supercontinuum fiber lasers” by A. Devine and A Grudinin, Laser Focus, Jun. 10, 2013), and the much smaller specialized erbium-doped optical fiber lasers operating at a central wavelength of approximately 1.56 microns. The U.S. Department of Defense has undertaken multiple research projects to prefect USPL for use in the mid wavelength infrared (MWIR) to long wavelength infrared (LWIR) regimes ranging from 2 microns to 12.5 microns (see “Recent Advancements in Ultrashort Pulse Lasers Shed New Light on Directed Energy Applications” by A Valenzuela et al in Defense Information Analysis Center, DSIAC Journal, Summer 2017: Vol. 4, Number 3). Use of USPLs in the well know low loss MWIR atmospheric widow of 3 to 5 microns and in the LWIR low loss atmospheric window of 8 to 12 microns is anticipated to be particularly significant in future FSO applications. It is anticipated that present day unidirectional and bidirectional point-to-point FSO communication links will find increasing applications and that more complex point-to-multi-point and multi-point-to-multi-point systems will become more common due to the recognized need for managing natural disasters such as fighting wild-fires and supervising battlefield situations.

There is an inherent property associated with all pulsed coherent optical sources such as USPLs. Their minimum optical spectral bandwidth is inversely related to their pulse width. So, for example, a USPL with a 100 femtosecond output pulse width would have a spectral bandwidth of approximately 1×10⁴ GHz, that is, (1/100 femtoseconds)=1/100×10¹⁵ seconds⁻¹=1×10¹³ Hz=1×10⁴ GHz). Achieving or even approaching, say, 1% of such a large potential bandwidth, say 100 GHz, in a practical optical communications system would represent a major future accomplishment. However, pushing the native pulse repetition rate of an erbium-doped fiber USPL from its typical maximum value of approximately 50 Mbit/sec to 100 Gbit/sec is technologically difficult. And even if it were accomplished, the power per pulse would be so diminished as to reduce the possibility of certain FSO communication transmission benefits, discussed below, that are believed to require higher peak powers (in the range of 5 kilo-Watt or greater). In contrast, using WDM-per-pulse strategy can increase the system bandwidth while maintaining essentially an undiminished optical power per pulse. This capability will be helpful to scale the capacity of the network to support anticipated exponential demand.

In view of this situation, a number of approaches are being considered or are actually under development to achieve substantially greater communication bandwidths for optical communication systems by alternative means. They all revolve around some sort of multiplexing schemes such as (1) employing an external pulse rate multiplier external to the USPL (see T. Chaffee et al U.S. Pat. No. 9,300,398 dated Mar. 29, 2016), (2) polarization state multiplexing (see R. Alfano et al, U.S. Pat. No. 7,106,972), and (3) a special type of wavelength multiplexing referred to herein as WDM-per-pulse. In this later case, each pulse from a USPL is sliced up into a multiplicity of spectral channels that can be independently modulated to carry data.

While all three of these approaches either singly or in combination have merit, the third approach, WDM-per-pulse, offers the potential of maximizing the optical pulse intensity during transmission for any specified data rate. And high peak optical pulse intensity (in the range of 5 kilo-Watts or greater) has been reported by some to be related to reduced optical attenuation in the atmosphere and thereby permitting greater transmission distances for a fixed USPL output power (see paper by J. Cabaniss and T. Chaffee, “Enhanced Performance for Ultrafast Lasers in Heavy Scattering Medium, Experimental Evidence for Theoretical Predictions” presented in 2008 (see https://www.spiedigitallibrary.org/conference-proceedings-of-spie/6457/64570X/Enhanced-performance-of-low-power-60mW-femtosecond-free-space-optical/10.1117/12.725395.short?SSO=1). Further, WDM-per-pulse when used in conjunction with optical fiber transmission eliminates the need for a multiplicity of narrow bandwidth laser sources tuned to a multiplicity of different channel wavelengths, as are employed in conventional WDM. Only a single USPL would be required using WDM-per-pulse.

Earlier work by Jean-Claude Diels et al. reported in U.S. Pat. No. 6,421,154 dated Jul. 16, 2002, describes a rather complex method of combining both pulse rate multiplication with WDM-per-pulse using discrete optical components requiring optical gratings and non-linear crystals and lenses. However, there is no indication that such a system has ever been constructed or operated.

Clearly, it would be desirable if any form of multiplexing of a USPL could be made practical to achieve higher digital transmission bit rates in either a fiber optic or FSO communication system than is currently practical. And, in particular, it would be desirable to accomplish this objective with low cost optical components that might be economically assembled into integrated photonic circuits that could be used in optical transmitter and receiver units.

### SUMMARY OF THE INVENTION

This invention relates to the design of a FSO or fiber optical communication system that that can operate in the WDM-per-pulse mode using cost effective integrated photonic circuits in both the transmitter and receiver units. While the integrated photonic circuit employed in the receiver unit is similar to those that were developed and are presently used in WDM fiber optic communication systems, the integrated photonic circuit employed in the transmitter unit is novel and as has not heretofore been used in any optical communication systems—neither FSO nor fiber optic systems.

By way of background, the key integrated photonic circuit component used in both the transmitter and receiver of a WDM fiber optic communication system is an arrayed waveguide grating (AWG). This is a well-developed passive optical component that does not require any electrical power to operate. One such AWG is employed in the transmitter to combine modulated laser beam outputs from a multiplicity of laser diodes each having a different spectral bandwidth onto a single optical fiber. Thus, the AWG can serve the function of a WDM-multiplexer. And at the receiver end of the WDM fiber optic system, another AWG, identical in design to the one in the transmitter but having the optical beam traveling in the reverse direction, is employed to split the multiplicity of laser beams traveling through the optical fiber into discrete spectral channels. When an AWG is used in the reverse like this, it serves as a WDM-demultiplexer.

The inventive concept for the integrated photonic circuit used in either the fiber optic or FSO transmitter unit is to use two AWGs that are mounted back-to-back on a common substrate. A linear array of optical modulators is located in between the two AWGs, forming a novel sandwich structure that is referred to as a WDM-per-pulse modulator. In operation, a light beam output from the USPL is directed into the input port of the first AWG associated with the WDM-per-pulse modulator. This causes the laser beam to be divided (sliced) into a multiplicity of contiguous spectral channels at the output of the first AWG. Each of these sliced optical channels is then directed into one of the multiplicity of high speed integrated optical modulators in a linear array that is sandwiched between the first and second AWGs. Upon exit from the modulator array, the sliced and now modulated optical channels are directed into the second AWG which serves the function to recombine them into a single beam that can then be relayed by discrete optics or fiber optics to the output beam transmission telescope associated with a FSO transmitter unit or to a longer transmission fiber optic cable that extends to the receiver unit. Of course, the above single beam could also be split into a multiplicity of beams by conventional beam splitting optics and directed to a multiplicity of beam transmission telescopes to accomplish the function of data transmission from a single point to remote multi-points.

When a FSO transmitted beam arrives at a remote receiver unit, it is collected by a receiver unit's telescope and is focused onto the core of an optical fiber that connects to the input port associated with the single AWG in the receiver unit. Alternatively, the receiver unit's telescope may be directly focused onto the input port of the single AWG, and thereby eliminate the need for a connecting optical fiber. The function of the AWG in the receiver unit is to demultiplex the received laser beam by dividing (slicing) and redirecting each of the modulated optical channels to an appropriate photodetector in a linear array. It would be advantageous to reduce both size and cost of the WDM-demultiplexer by mounting the receiver unit AWG and a linear array of photodetectors closely together on a common substrate forming an integrated photonic circuit.

[In many cases where optical communications is employed, it is desirable to be able to transmit data both to and from a remote unit to establish a bi-directional communication link. In such cases, discrete transmitter and receiver units can be deployed at both ends of the communication's link. However, in the case of FSO communications, it is often cost effective to use a common telescope for both transmitting a laser beam to the remote location and receiving a return beam from that location with data. To avoid cross-talk between the outgoing and incoming laser beams, it is helpful to use different polarization states (say, horizontal and vertical) for the outgoing and incoming laser beams or to use non-overlapping spectral bands for the outgoing or incoming laser beams

### BRIEF DESCRIPTION OF THE DRAWINGS

The above SUMMARY OF THE INVENTION as well as other features and advantages of the present invention will be more fully appreciated by reference to the following detailed descriptions of illustrative embodiments in accordance with the present invention when taken in conjunction with the accompanying drawings, wherein:

FIG. 1 is a schematic of a typical prior art fiber optic WDM communication system for relaying data from one point to another.

FIG. 2 is schematic of a FSO WDM-per-pulse communication system for relaying data from one point to another.

FIG. 3 is a schematic of the new FSO WDM-per pulse bidirectional transceiver unit with a common telescope.

FIG. 4 is a diagram of the WDM-per-pulse modulator employed in the transmitter unit.

FIG. 5A is a diagram of a typical prior art AWG that serves to explain its operation.

FIG. 5B is a diagram that shows the similarity of an AWG to a conventional optical prism.

### DETAILED DESCRIPTION OF THE DRAWINGS

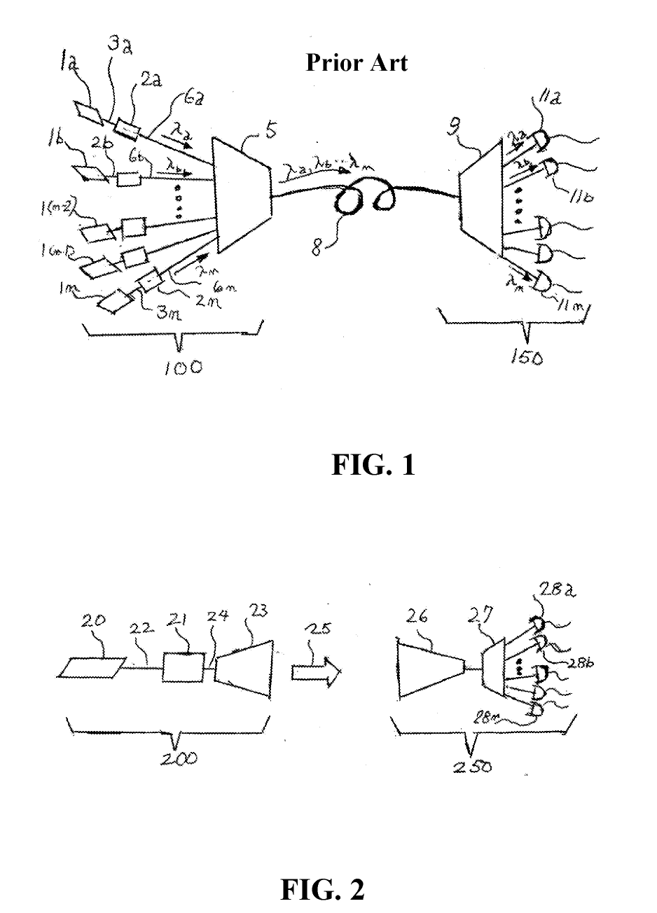

FIG. 1 is a schematic of a typical prior art fiber optic WDM communication system for relaying data from transmitter unit 100 to a receiver unit 150. There is a multiplicity of laser sources, 1a through 1n, in the transmitter unit, 100, whose outputs are coupled to a multiplicity of optical modulators, 2a through 2n, either directly or through short lengths of optical fibers, 3a through 3n. Each laser emits a laser beam with a different narrow spectral bandwidth centered at wavelengths, λₐ through λₙ. Then, all of the modulated laser beams, which serve as discrete communication channels, are directed to a multiplicity of input ports on a WDM multiplexer 5 either directly or through short lengths of optical fibers, 6a through 6n. All of these beams are combined within the WDM-multiplexer 5 to form a single multiplexed output beam 7 that is then transmitted along a transmission optical fiber 8 to a remote receiver unit, 150. All laser beams in this figure are identified by their wavelengths, λₐ through λₙ, shown directly over arrows pointing in the direction of beam propagation. The transmission optical fiber 8 terminates at the input port of a WDM-demultiplexer 9 that separates the combined beams back into discrete optical channels with wavelengths λₐ through λₙ that are either directed by optical fibers or by proximity contact to a multiplicity of photodetectors, 11a through 11n. Each photodetector is followed by electronics (not shown) to recover the communicated data.

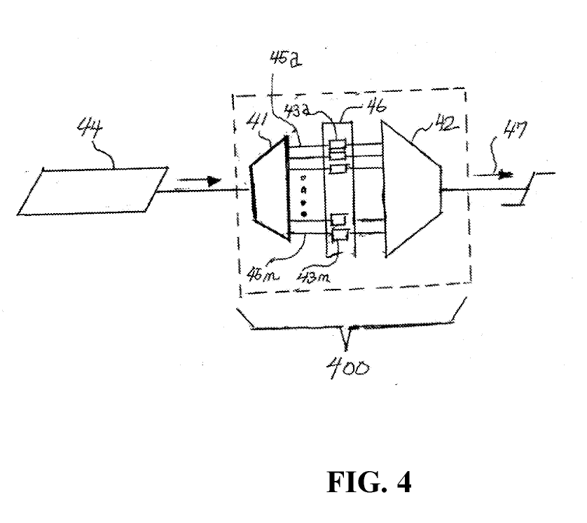

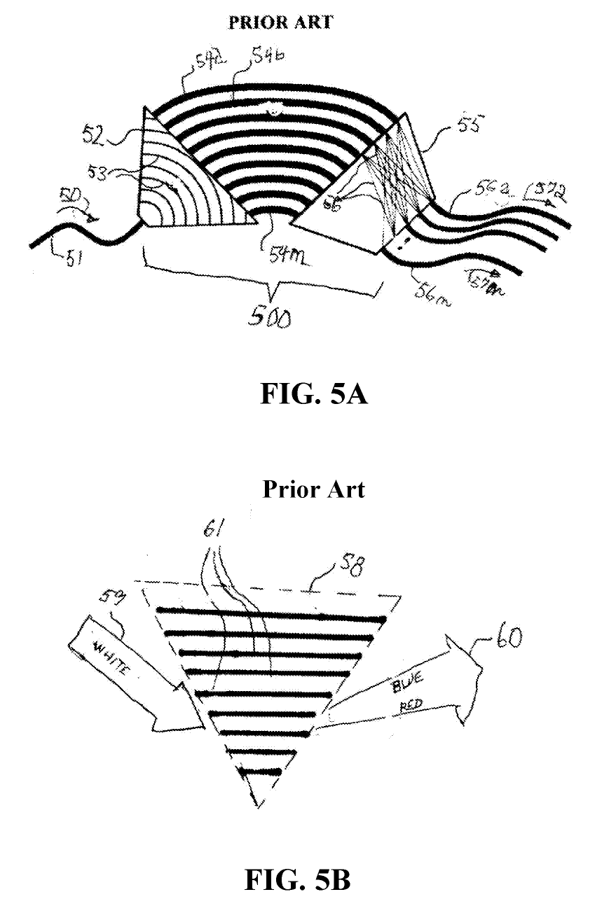

FIG. 2 is schematic of a FSO WDM-per-pulse communication system for relaying data from a transmitter unit 200 to a remotely located receiver unit 250. In this case, there is only a single USPL laser source, 20, in the transmitter unit whose outputs is coupled to a single WDM-per-pulse modulator 21 either directly or through a short length of optical fiber 22. The broad spectral bandwidth of the UPSL is divided into a multiplicity of discrete narrower bandwidth channels within the WDM-per-pulse modulator 21. Also, within this modulator, each channel is individually modulated and recombined back into a single broad spectral bandwidth laser beam before exiting the WDM-per-pulse modulator 21 The details of the operation of this modulator are more fully explained with the aid of FIG. 4 and FIGS. 5A and 5B, below. The output laser beam from the WDM-per-pulse modulator 21 is then directed to a transmitting telescope 23 using either a short optical fiber 24 or some discrete optical components. The output beam 25 from the transmitting telescope 23 is transmitted down range to the receiver unit 250 through free space to receiving telescope 26. This telescope focuses the received laser beam onto the input port of a WDM-demultiplexer 27. From the output of the WDM-demultiplexer, the schematic of the FSO WDM-per-pulse communication system is functionally identical to the fiber optic WDM system shown in FIG. 1. The WDM-demultiplexer 27 separates the broad bandwidth input beam back into discrete optical channels with a multiplicity of wavelengths, λₐ through λₙ, that are either directed by optical fibers or by proximity contact to a multiplicity of photodetectors, 28a through 28n, that are each followed by electronics (not shown) to recover the communicated data.

Although not shown in FIG. 2, the WDM-per-pulse transmitter unit 200 could also be used in conjunction with a fiber optic communication system rather than a FSO system.

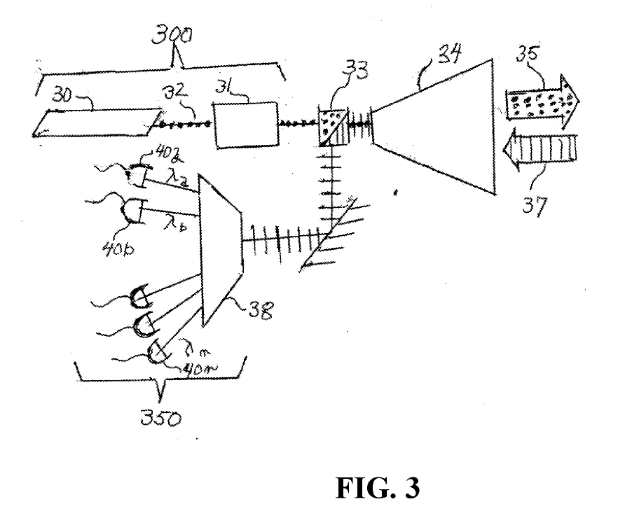

FIG. 3 is a schematic of a FSO WDM-per pulse bidirectional transceiver unit with a common telescope. It consists of a transmitter unit 300 and receiver unit 350 at the same location. The transmitter unit has a USPL source 30 connected to a WDM-per-pulse multiplexer 31 either directly or by an optical fiber 32. The output polarization of the USPL 30 has its electric field normal to the plane of this figure, as shown by solid dots along the laser beam path. The output from the WDM-per-pulse multiplexer then passes through a polarization state beam splitter 33 and continues on to a telescope 34 that transmits the laser beam 35 through free space to another bidirectional transceiver (not shown) in a remote location. The laser beam 37 arriving from the remote bidirectional transceiver unit enters the common telescope 34. The polarization state of this return laser beam 37 is in the plane of the figure as shown by a series of short lines in this plane along the beam path. The polarization state beam splitter 33 directs the arriving laser beam to the WDM-demultiplexer 38. From this point, the schematic of the receiver unit 350 for the bidirectional FSO WDM-per-pulse communication system is functionally identical to the fiber optic WDM system shown in FIG. 1. The WDM-demultiplexer 38 separates the broad bandwidth beam received from a USPL at the remote transceiver (not shown) into discrete optical channels with a multiplicity of wavelengths, λₐ through λₙ, that are either directed by optical fibers or by proximity contact to a multiplicity of photodetectors, 40a through 40n, that are each followed by electronics (not shown) to recover the communicated data.

FIG. 4 is a diagram of the simplest form of a WDM-per-pulse modulator 21 employed in the FSO transmitter units shown in FIG. 2 or the WDM-per-pulse modulator 31 employed in the bidirectional transceiver unit shown in FIG. 3. In this form, the WDM-per-pulse modulator 400, shown in FIG. 4, uses two AWGs, 41 and 42, mounted back-to-back on a common substrate. A linear array of optical modulators 46 comprised of n individual modulators, 43a through 43n, is located in between the two AWGs, 41 and 42, forming a sandwich structure that makes up the WDM-per-pulse modulator. In operation, the laser beam output from the USPL 44 is directed into the input port of the first AWG 41. This causes the laser beam to be divided (sliced) into a multiplicity of contiguous spectral channels, 45a through 45n, at the output of the first AWG, 41. Each of these sliced optical channels is then directed into one of the multiplicity of high speed integrated electro-optic modulators, 43a through 43n, located in a linear array 46 that is sandwiched between the first and second AWGs, 41 and 42.

To ensure high speed operation, a good choice for the electro-optic modulators would be to employ a Mach-Zhender design that is fabricated on a substrate of high performance electro-optic material like lithium niobate (LiNbO₃). And the number and spacing between adjacent optical modulators should be equal to that of the number and spacing between the AWG's adjacent spectrally sliced ports so that these components may be butt-coupled with accurately aligned and co-axial input and output ports.

Upon exit from the modulator array, the sliced and now modulated optical channels, 44a through 44n, are directed into the second AWG 42 which serves to recombine all of these optical cannels into a single beam 47 that can then be relayed by discrete optical components or an optical fiber to the output beam transmission telescope associated with FSO transmitter unit or the transceiver unit or to an optical fiber cable that transports the optical beam all the way to the receiver unit.

In the design of a FSO WDM-per-pulse optical communication system, careful consideration must be given to selecting the total number of WDM channels, n. The primary consideration must go to ensuing that the optical power level in each channel is adequate to deliver a sufficient number of photons per digital bit to the photodetector assigned to that channel in the receiver unit. It is well known that approximately 100 photons per bit per channel or greater arriving at a well-designed detector assures high quality signal reception with an error rate less than, say, 1 error per every 1 billion bits received (a 1×10⁻⁹ bit error rate). It is a straight forward calculation to show that 100 photons per bit for a typical erbium-doped fiber laser operating at 50 MBits/sec would correspond to an optical power level of approximately 5×10⁻¹⁰ Watts at each detector and a total of (n×5×10⁻¹⁰) Watts of received optical power would be required for the entire array of n photodetectors. So, if the typical erbium-doped fiber laser has a beam output power of, say, 0.1 Watts, the overall transmission margin for the communication system would be (0.1 Watts)/(n×5×10⁻¹⁰ Watts), equal to a dimensionless transmission margin of (2/n×10⁹). Finally, assuming that atmospheric attenuation might reduce the initial power in the USPL beam by a factor of 1×10⁵ (or, equivalently, 50 dB transmission loss), there remains a system margin of 2/n×10⁴. If this margin were set to its lowest acceptable value equal to unity (1), one can calculate that the total number of spectral channels, n, must be 2×10⁴ (20,000) or less for the system to operate satisfactorily. And in this case, the total bit rate would be limited to 20,000×50 MBits/sec=1,000 GBits/sec or less. Although this is a strikingly high bit rate that has not yet been achieved in a FSO communication system, it demonstrates the considerable potential of applying WDM-per-pulse to FSO communications systems.

Based on the present state-of-the- art related to the design and manufacture of arrayed gratings, up to 64 optical output channels can be reasonably achieved in a single AWG (see Sai Hu, “Design and Simulation of Novel Arrayed Waveguide Grating By Using the Method of Irregular Sampled Zero-Crossings”, Purdue University—Electrical and Computer Engineering Technical Report 12-1-2002), and up to 160 channels represents a current design limit. Nevertheless, the practical limits on the channel numbers associated with present AWGs can be overcome by using two or more AWGs in tandem. For example, a first AWG could be used to divide a laser beam from a USPL into 64 relatively broad spectral channels. Then, these channels could be divided further by, directing the 64 output beams from the first AWG into the input ports of 64 additional AWGs having an identical design to the first one to realize a total of 64×64=4,096 total output channels.

A significant design objective for a FSO system employing an USPL would be a bit rate of 1.25 GBits/sec. This rate could be achieved by employing the erbium-doped fiber laser, discussed above, with a single 25-channel AWG on the input and output sides of the WDM-per-pulse modulator. And if, for example, a single 8-channel AWG were followed by a second group of 8 additional AWGs each having 25 output channels, the total communication system bit rate would be increased to 10 GBits/sec (1.25 GBit/sec×8=10 GBit/sec).

FIG. 5A is a diagram of a typical prior art AWG 500 that serves to explain its operation. A laser beam, 50, having a broad spectral bandwidth traveling in an input optical fiber 51 enters a trapezoidal section 52 of an integrated photonic circuit where it diverges with wave fronts shown by the successive circular segments 53. At the exit of the trapezoidal section 52 the wave fronts are divided into n contiguous segments that exit trapezoidal section 52 through n exit ports that are connected to a multiplicity of surface optical waveguides, 54a through 54n, having diminishing lengths, going from 54a to 54n. This group of waveguides, 54a through 54n, terminates at another trapezoidal section 55 and, finally the optical power therein, shown by a number of typical light rays, 56, exits onto a multiplicity of output optical fibers (or surface waveguides), 56a through 56n. Each of the output beams, 57a through 57n, become discrete optical channels with their central wavelengths increasing from output beam 57a to output beam 57n.

While the above described operation of the AWG 500, in FIG. 5A may, a first, seem to be almost magical, the physics of its operation is similar to that of a conventional glass prism 58 shown by its dotted outline in FIG. 5B. It is well know that such a prism disburses an incoming white light beam 59 into a full spectrum of output colors 60 (blue through red) which, by analogy, may be thought of as discrete optical channels. A group of straight horizontal waveguide channels 61 have been inserted within the dotted prism outline 58 to show how a transparent glass prism could be well approximated by a series of such parallel waveguide channels. In principle, the waveguide channels, 54a through 54n, in FIG. 5A could be made straight, as they are in FIG. 5B. However, they are typically manufactured with the curvature shown in FIG. 5A to reduce the overall horizontal length of this integrated photonic circuit and thereby reduce its manufacturing cost.

To compete the discussion of the analogy between the AWG in FIG. 5A and the prism in FIG. 5B, it should be pointed out that when the light beam first emerges from the prism 58 shown in FIG. 5B it is not fully disbursed into a recognizable rainbow spectrum. Rather, the emerging light must travel some minimum distance so that the various overlapped colors can separate. Such a minimum distance is also required for the proper operation of the AWG in FIG. 5A. And, by design, that distance, is equal to the height of the trapezoidal section 55 between its parallel surfaces. Similarly, in order to function properly, a prism also requires that the input white light beam 59 be spread out over the input surface of the prism. This is also the case for the AWG in FIG. 5A where the trapezoidal section 52 provides the necessary distance for the laser beam 50 to expand to full illuminate all of the waveguide channels, 54a through 54n.

While the above disclosure describes certain aspects of the integrated photonic chip WDM-per-pulse modulator design and assembly methods that can be beneficially used in FSO communication systems employing a USPL, the examples disclosed should merely be considered to be representative of many related alternatives. It is therefore to be understood that the scope of this invention is broader than the design and methods described in the specification and following claims and that the apparatus and methods described herein relate broadly to the design, assembly and use of the described integrated photonic circuit WDM-per-pulse modulator and optical communications systems employing such modulators.

The invention claimed is:

1. A free space optical (FSO) communication system for
(1) unidirectional point-to-point transmission,
(2) bidirectional point-to-point transmission,
(3) bidirectional point-to-multi-point transmission, or
(4) bidirectional multi-point-to-multi-point transmission with each point-to-point optical interconnection made up using one or more transmitter unit(s) each comprised of an ultra-short pulsed laser (USPL), one integrated photonic WDM-per-pulse multiplexer circuit or more than one integrated photonic WDM-per-pules multiplexer circuits connected in tandem, a transmitting telescope, and associated electronics that are located at one point and one or more receiving units each comprised of a receiving telescope, WDM-demultiplexer and photodetector array and associated electronics located at another point.

2. A FSO communication system as in claim 1 in which a single telescope is used for both transmitting and receiving laser beams that have either orthogonal polarization states or non-overlapping spectral bands that propagate in opposite directions from one single point to another single point.

3. A FSO communication system as described in claim 1 in which the USPL is an erbium-doped fiber optic laser operating at a fundamental wavelength of approximately 1.56 microns.

4. A FSO communication system as described in claim 2 in which the USPL is an erbium-doped fiber optic laser operating at a fundamental wavelength of approximately 1.56 microns.

5. A FSO communication system as described in claim 1 in which the USPL is an erbium-doped fiber optic laser operating at a frequency doubled wavelength of approximately 0.78 microns.

6. A FSO communication system as described in claim 2 in which the USPL is an erbium-doped fiber optic laser operating at a frequency doubled wavelength of approximately 0.78 microns.

7. A FSO communication system as described in claim 1 in which the USPL is an Ti: Sapphire laser operating at a fundamental wavelength in the range 0.65 to 1.10 microns.

8. A FSO communication system as described in claim 2 in which the USPL is an Ti: Sapphire laser operating at a fundamental wavelength in the range 0.65 to 1.10 microns.

9. A FSO communication system as described in claim 1 in which the USPL is a supercontinuum laser operating at a fundamental wavelength in the range 0.38 to 2.40 microns.

10. A FSO communication system as described in claim 2 in which the USPL is a supercontinuum laser operating at a fundamental wavelength in the range 0.38 to 2.40 microns.

11. A FSO communication system as described in claim 1 in which the USPL operates at a fundamental wavelength in the range 2.0 to 12.5 microns.

12. A FSO communication system as described in claim 2 in which the USPL operates at a fundamental wavelength in the range 2.0 to 12.5 microns

13. A FSO communication system as described in claim 1 in which one or more integrated photonic WDM-per-pulse multiplexer circuit(s) are each comprised of two arrayed waveguide gratings (AWGs) of identical design that are positioned back-to-back with a single linear array of integrated high speed optical modulators located between these AWGs.

14. A FSO communication system as described in claim 2 in which one or more integrated photonic WDM-per-pulse multiplexer circuit(s) are each comprised of two arrayed waveguide gratings (AWGs) of identical design that are positioned back-to-back with a single linear array of integrated high speed optical modulators located between these AWGs.

15. An integrated photonic WDM-per-pulse multiplexer circuit in which the high speed optical modulators are of an electro-optic Mach-Zhender type and are fabricated on a lithium niobate (LiNbO₃) substrate.

16. An integrated photonic WDM-per-pulse multiplexer circuit as in claim 15 in which the number and spacing between adjacent optical modulators is equal to that of the number and spacing between the AWG's adjacent spectrally sliced ports so that these components may be butt-coupled with accurately aligned and co-axial input and output ports.

17. An integrated photonic WDM-per-pulse multiplexer circuit as in claim 15 in which the number of optical modulators is 20,000 or less.

18. An integrated photonic WDM-per-pulse multiplexer circuit as in claim 15 in which the number of optical modulators is between 10 and 1,000.

19. A unidirectional point-to-point fiber optical communication system consisting of a transmitter unit comprising an ultra-short pulsed laser (USPL), one or more integrated photonic WDM-per-pulse multiplexer circuit(s), and associated electronics located at one end and a receiving unit comprising a receiving WDM-demultiplexer and photodetector array and associated electronics at a the other end.

20. A bidirectional point-to-point fiber optic communication system in which one or more integrated photonic WDM-per-pulse multiplexer circuit(s) are each comprised of two arrayed waveguide gratings (AWGs) of identical design that are positioned back-to-back with a single linear array of integrated high speed optical modulators located between these AWGs.
